(19) United States
(12) Patent Application Publication
(10) Pub. No.: US 2008/0298231 A1
(43) Pub. Date: Dec. 4, 2008

(54) Ring node and redundancy method

(75) Inventor: Makoto Takakuwa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/081,952

(22) Filed: Apr. 23, 2008

(30) Foreign Application Priority Data
Apr. 24, 2007 (JP) JP2007-114237

(51) Int. Cl. G06F 11/00

(52) U.S. Cl. 370/223

(57) ABSTRACT

To provide a technology capable of improving fault-tolerance by redundancy-structuring each of ring nodes building up a ring network with an active termination block and a non-active termination block and, if a fault occurs in the active termination block, continuing an operation by switchover to the non-active termination block. A ring node is configured such that data from a terminal side is forwarded to an active termination block and to a non-active termination block, source information of the data is determined and registered in a database, the data is transmitted to the ring from a ring-side interface, the data received from the ring is forwarded to the active termination block and to the non-active termination block, destination information of the data is determined by referring to the database and forwarded to a terminal-side interface, and the terminal-side interface selects the data from the active termination block and forwards the selected data to the terminal side.

This application claims the benefit of Japanese Patent Application No. 2007-114237 filed on Apr. 24, 2007 in the Japanese Patent Office, the disclosure of which is herein incorporated in its entirety by reference.

### BACKGROUND OF THE INVENTION

The present invention relates to a technology that facilitates switchover of a ring node when a fault occurs in any one of the ring nodes building up a ring network.

Over the recent years, telephone networks built up by existing circuit switching technologies have been replaced by IP-packet-based communication networks using packet switching technologies, and, along with this tendency, Layer-2 backbone transmission systems have gradually been replaced by Ethernet (registered trademark)-based transmission systems having high affinity with IP packets.

A large capacity and high fault-tolerance are, however, demanded of the backbone circuit, and devices constructing the backbone transmission system take in new technologies on an Ethernet basis so as to meet requests on the market and follow the large capacity and the fault-tolerance as before.

[Patent document 1] Japanese Patent Laid-Open Publication No. 2001-036557

### SUMMARY OF THE INVENTION

From the requests for the large capacity and the fault-tolerance, a network based on a ring topology is devised also in the packet-based communication system. For example, RPR (Resilient Packet Ring; IEEE802.17) was standardized by the IEEE (the Institute of Electrical and Electronic Engineers, Inc.), and one known system is a system in which this RPR technology is applied to a L2 switch device.

An RPR communication system (IEEE802.17a) in FIG. 1 is a system where if a fault occurs in a transmission path within a ring and if the fault occurs in the node as well, in the same way, the packets are transmitted in a way that bypasses the fault-occurred position, thereby attaining a quick recovery of the communication path.

For instance, when transmitting the packets to a node C from a node A, the node A transmits the packets via both of an active-side route W to the node C through a node B and a standby-side route P to the node C through a node D, and the node C receives the packets normally via the active-side route W.

Then, if the fault occurs in the node B on the active-side route W, the route is switched over to the standby-side route P via which the packets are received.

Thus, the communications do not get disconnected by redundancy-structuring the communication routes even if the fault occurs on the route, thereby ensuring the high fault-tolerance.

The active-side route and the standby-side route are, however, always occupied, and hence such a problem exists that an availability efficiency of the transmission path is low.

Such being the case, Spatial Reuse defined by IEEE802.17b is focused in order for the L2 switch device to highly efficiently accommodate the packets (FIG. 2). The Spatial Reuse is a scheme for highly efficiently accommodating the packets by segmenting the ring and letting the packets through the respective segmented rings simultaneously.

For example, in the case of transmitting the packets to the node C from the node A, the node A normally transmits the packets to the node C via the node B, however, if a fault occurs in the node B on the route W, the route is switched over so as to transmit the packet to the node C via the node D.

This scheme enables, since the circuit extending from the node A via the node D to the node C can accommodate other packets at the normal state, the availability efficiency of the transmission path to be improved while ensuring the fault-tolerance.

According to this system (IEEE802.17b), however, as illustrated in FIG. 3, on the occasion of letting the packets through a bypass to a route P when the fault occurs, if a route segment between the node D and the node C on the bypath route P accommodates packets of another traffic E, there is a possibility that a congestion might occur.

Such being the case, one aspect of an embodiment provides a technology capable of improving fault-tolerance by redundancy-structuring each of ring nodes building up a ring network with an active termination block and a non-active termination block and, if a fault occurs in the active termination block, continuing an operation by switchover to the non-active termination block.

One aspect of an embodiment adopts the following configurations in order to solve the problems given above.

Namely, according to one aspect of an embodiment, a ring node building up a ring network comprises:

a ring-side interface receiving data from the ring or transmitting the data to the ring;

an active termination block forwarding the data from the ring to a terminal side or forwarding the data from the terminal side to the ring;

a non-active termination block redundancy-structuring a forwarding function of the data by having the same configuration as the active termination block has; and

a terminal-side interface selecting the data sent from the active termination block in the data from the active termination block and from the non-active termination block, then forwarding the selected data to the terminal side, and forwarding the data from the terminal side to the active termination block and to the non-active termination block,

each of the active termination block and the non-active termination block including:

a source determining unit determining source information of the data received from the terminal side, and registering the source information in a database; and

a destination determining unit determining destination information of the data received from the ring by referring to the database.

Further, according to one aspect of an embodiment, a redundancy method for a ring node including a ring-side interface, an active termination block, a non-active termination block and a terminal-side interface, is executed by the ring node and comprises:

a step of getting the terminal-side interface to forward data from a terminal side to the active termination block and to the non-active termination block;

a step of getting the active termination block and the non-active termination block to determine source information of the data received from the terminal side and to register the source information in a database;

a step of getting the active termination block to forward the data to the ring-side interface;

a step of getting the ring-side interface to send the data to the ring;

a step of getting the ring-side interface to receive the data from the ring and to forward the data to the active termination block and to the non-active termination block;

a step of getting the active termination block to determine destination information of the data received from the ring-side interface by referring to the database, and to forward the data to the terminal-side interface; and

a step of getting the terminal-side interface to select the data from the active termination block in the data from the active termination block and from the non-active termination block, and to forward the selected data to the terminal side.

According to one aspect of an embodiment, it is feasible to provide the technology capable of improving the fault-tolerance by redundancy-structuring each of the ring nodes building up the ring network with the active termination block and the non-active termination block and, if the fault occurs in the active termination block, continuing the operation by switchover to the non-active termination block.

With these configurations, even if the fault occurs in the ring node, the occurrence of the congestion can be restrained without any bypass of the packets on the ring network.

Further, the databases of the active termination block and of the non-active termination block are synchronized with each other, thereby smoothly switching over the termination block.

### BRIEF DESCRIPTION OF THE DRAWINGS

FIG. 1 is an explanatory diagram of a conventional example.

FIG. 2 is an explanatory diagram of the conventional example.

FIG. 3 is an explanatory diagram showing occurrence of a fault.

FIG. 4 is a schematic diagram of a whole RPR system.

FIG. 5 A is a block diagram of a ring node.

FIG. 5 B is a block diagram of an RPR block.

FIG. 5 C is a block diagram of a packet block.

FIG. 6 is a diagram showing uplink data.

FIG. 7 is a diagram showing downlink data.

FIG. 8 is a diagram showing a data flow in a first modified example.

FIG. 9 is a diagram showing a data flow in a second modified example.

FIG. 10 is a diagram showing a data flow in a third modified example.

FIG. 11 is a diagram showing a data flow in a fourth modified example.

FIG. 12 is an explanatory diagram of flooding on an RPR layer.

FIG. 13 is an explanatory diagram of the flooding in a packet network IF block.

FIG. 14 is an explanatory diagram showing how packet FDBs are synchronized at a normal state.

FIG. 15 is an explanatory diagram showing how RPR FDBs are synchronized at the normal state.

FIG. 16 is an explanatory diagram of initial synchronization of the databases.

FIG. 17 is an explanatory diagram of the initial synchronization of the databases.

FIG. 18 is an explanatory diagram of the initial synchronization of the databases.

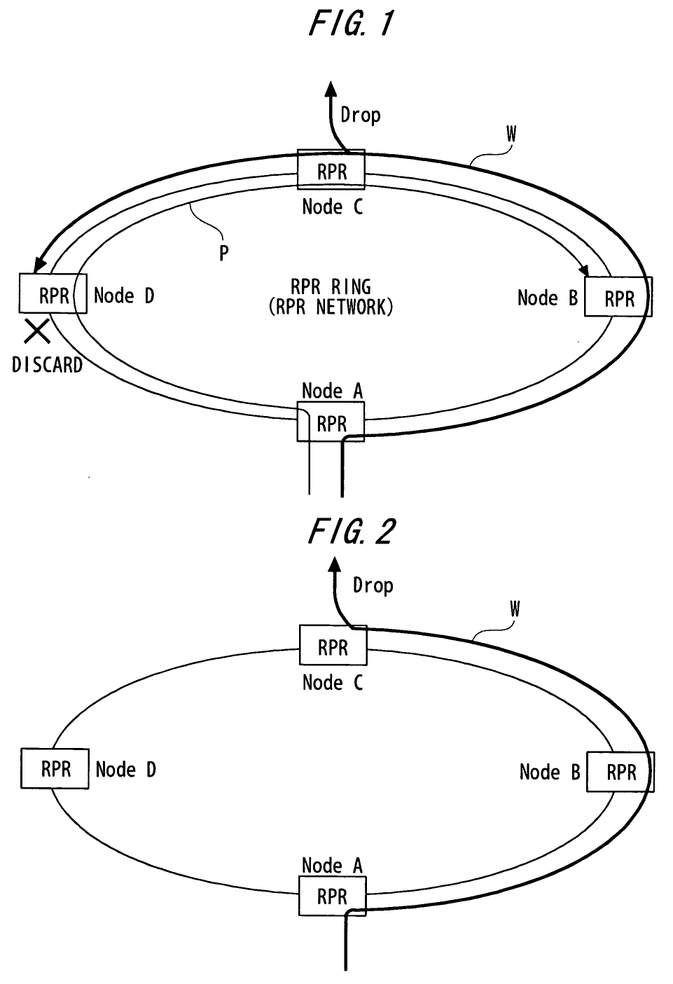

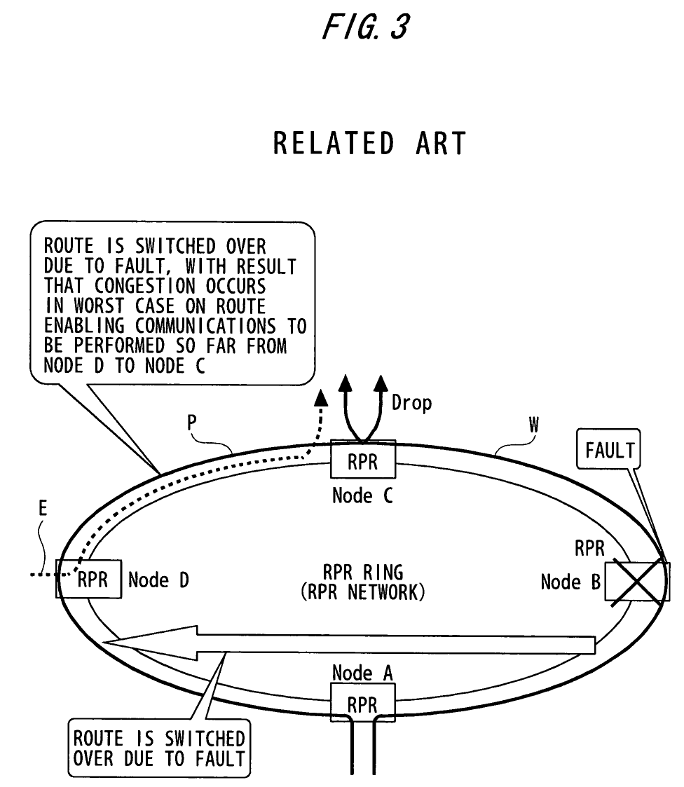

### DETAILED DESCRIPTION OF THE INVENTION

A best mode for carrying out the present invention will hereinafter be described with reference to the drawings. A configuration in the following embodiment is an exemplification, and the present invention is not limited to the configuration in the embodiment.

### §1. CONFIGURATION OF DEVICE

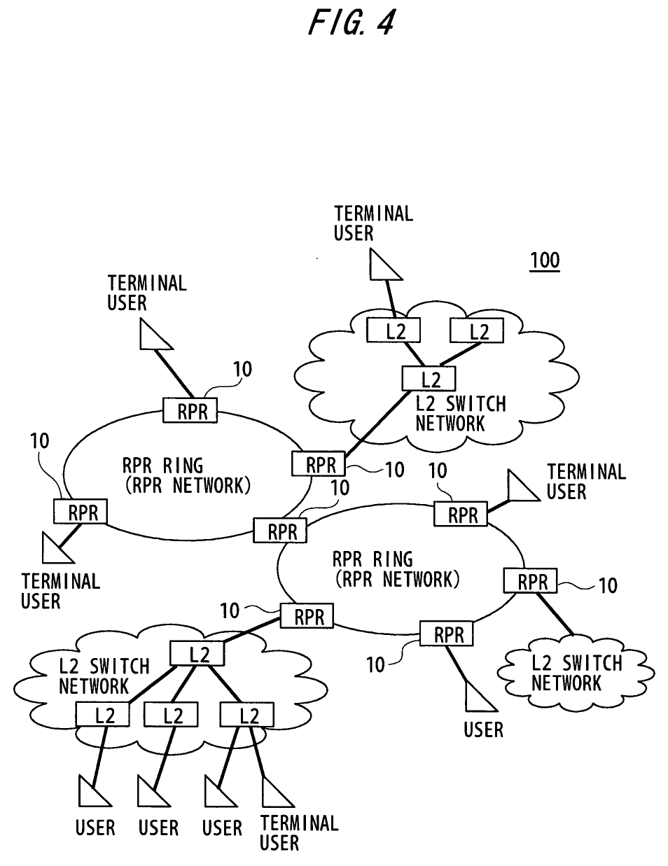

FIG. 4 is a schematic view of an RPR communication system according to the embodiment. A system 100 includes ring networks (which will hereinafter be also termed simply rings or ringlets) L that are linked to each other to configure a backbone communication circuit, and L2 networks (terminal-side networks) having L2 switch devices under the ring networks L.

Each of ring nodes 10 building up the RPR communication system 100 in the embodiment is a device pursuant to IEEE802.17b, and has a scheme of improving a fault-tolerance by taking a redundant structure of termination blocks so as not to initiate a ring protection function to the greatest possible degree. Accordingly, even if a fault occurs in the termination block, the operation can continue by switching over this fault-occurred termination block to another termination block, and the ring protection function is not initiated, thereby preventing a communication bandwidth from being reduced.

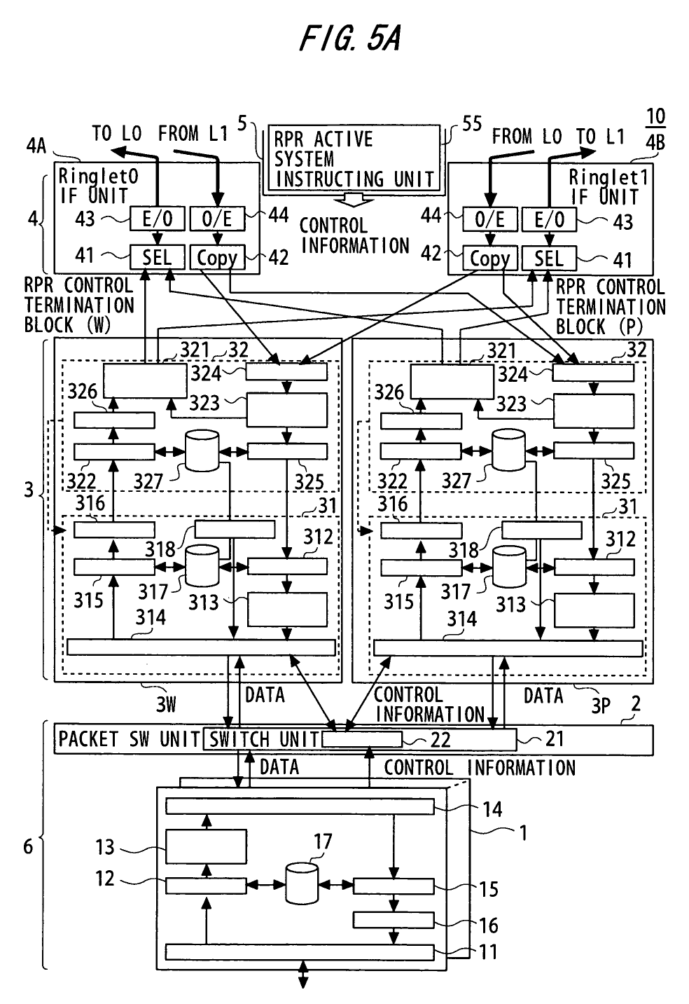

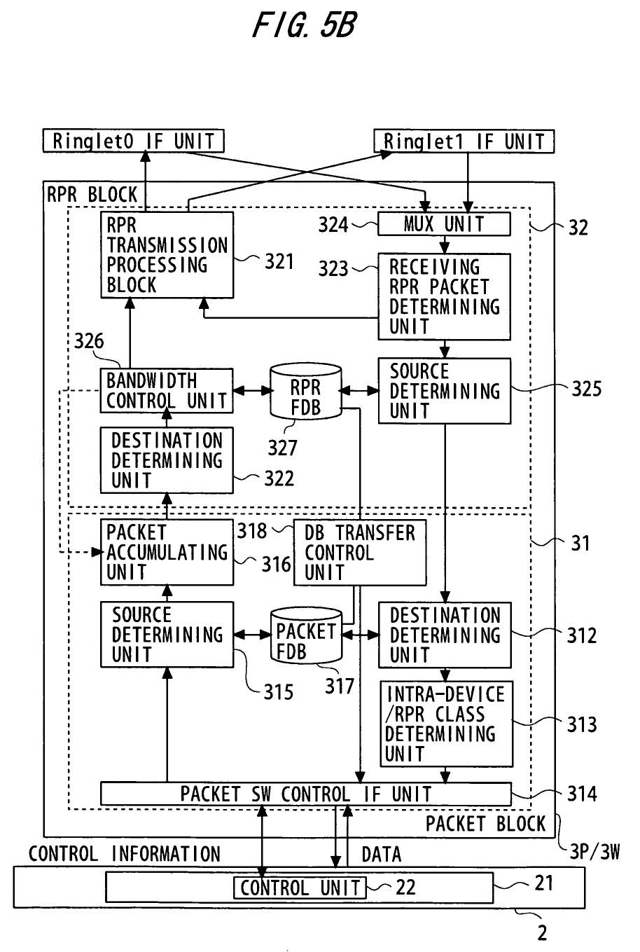

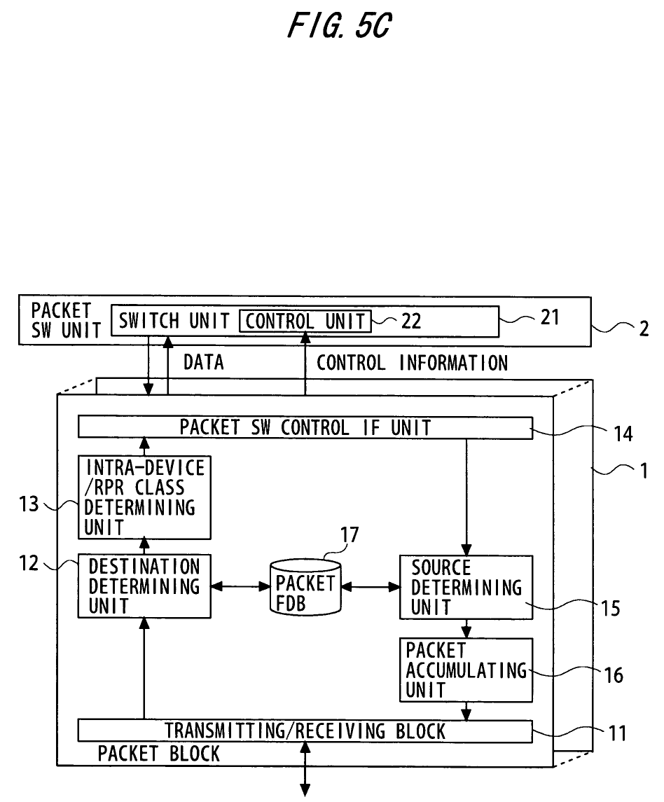

FIG. 5 is a function block diagram of the ring node 10. As illustrated in FIG. 5, the ring node 10 includes a packet network (interface) termination block 1, a packet SW (switch) unit 2, an RPR packet termination block (RPR card) 3, a ringlet IF unit 4 and a system control unit 5.

Further, each block is divided into detailed function blocks that will be explained next.

<Packet Network IF Block 1>

The packet network IF block 1 includes a transmitting/receiving block 11, a destination determining unit 12, an intra-device/RPR class determining unit 13, a packet SW control IF unit 14, a source determining unit 15, a packet accumulating unit 16 and a packet FDB (Forwarding Data Base) unit 17.

The transmitting/receiving block 11, which is related to a so-called PHY (PHYsical layer) and MAC (Media Control Access), perform mutual conversions of intra-device signal formats with respect to the packet network.

The destination determining unit 12 searches, based on header information of an inputted packet, through the packet FDB, and thus determines which forwarding destination, i.e., which port within the nodes the packet is forwarded to.

The class determining unit 13 determines an intra-device QoS (Quality of Service) class and RPR class of the inputted packet.

The packet SW control IF unit 14 transmits and receives data to and from the packet SW unit 2, and controls the transmission and the reception of the data between the packet network IF block 1 and the packet SW unit 2.

The source determining unit 15 determines where the packet forwarded from another packet network IF block or from the RPR card 3 comes from within the device, and reflects this information in the packet FDB.

The packet accumulating unit 16 temporarily accumulates the packets forwarded from the packet SW unit 2 in order to output the packet corresponding to a destination rate.

The packet FDB (Forwarding Data Base) unit 17 is a database for storing the destination information.

<Packet SW Unit 2>

Further, the packet SW (Switch) unit 2 has a SW unit 21 and a control unit 22.

The SW unit 21 switches, based on switching information of a forwarding destination, the data and thus forwards the packet to a desired destination.

The control unit 22 arbitrates between a plurality of [packet SW control IF units] connected to the packet SW unit 2, and gives a packet forwarding instruction and a packet stopping instruction. It is to be noted that the packet SW unit 2 and the packet network IF block 1 in the embodiment configure a terminal-side interface 6 according to the embodiment.

<RPR Card 3>

The RPR card (RPR packet termination block) 3 is redundantly constructed of an active RPR card (active termination block) 3W and a non-active (standby) RPR card (non-active termination block) 3P. Namely, each of the active RPR card 3W and the non-active RPR card 3P has the same construction including a packet block (terminal-side block) 31 and an RPR block (ring-side block) 32.

The packet block 31 includes a destination determining unit 312, an intra-device/RPR class determining unit 313, a packet SW control interface (IF) unit 314, a source determining unit 315, a packet accumulating unit 316 and a packet FDB (Forwarding Data Base) unit 317.

The destination determining unit 312 searches, based on header information of the inputted packet, through the packet FDB, and thus determines which forwarding destination, i.e., which port within the nodes the packet is forwarded to.

The class determining unit 313 determines the intra-device QoS class and RPR class of the inputted packet.

The packet SW control IF unit 314 transmits and receives the data to and from the packet SW unit 2, and controls the transmission and the reception of the data between the packet network IF block 1 and the packet SW unit 2.

The source determining unit 315 determines the source by specifying which card and which port of the card the forwarded packet comes from within the device, and reflects (registers) this transmitting information specifying the source in the packet FDB 317.

The packet accumulating unit 316 temporarily accumulates the packets forwarded from the packet SW unit 2 in order to output the packet corresponding to the destination rate.

The packet FDB unit 317 is a database for storing the destination information.

The RPR block 32 includes an RPR transmission processing block 321, a destination determining unit 322, a bandwidth control unit 326, a MUX (Multiplexer) unit 324, a receiving RPR packet determining unit 323, a source determining unit 325 and a RPR FDB unit 327.

The RPR transmission processing block 321 converts the packet into a format suited to the RPR ring, and forwards, based on a result of the determination made by the destination determining unit 322, the packets in a way that allocates the packets to a ringlet L0 and a ringlet L1 (ringlet IF units 4A, 4B).

The destination determining unit 322 searches for (determines), based on the destination information accumulated in the RPR FDB, the destination to which the packet is forwarded to, i.e., searches for which node in the RPR ring the packet is forwarded to.

The bandwidth control unit 326 controls a bandwidth enabling the packet to be inserted (added) into the RPR ring.

The MUX unit 324 makes confluent (multiplexes) the packets in order to relay the bi-directional packets forwarded from the neighboring RPR node and coming from the ringlet L0 and the ringlet L1 to one receiving RPR packet determining unit 323.

The receiving RPR packet determining unit 323 determines whether the packet inputted from the ring is relayed to the next node or forwarded to a subordinate under the self-device. Then, the receiving RPR packet determining unit 323, if the packet is determined to be relayed to the next node, forwards the packet to RPR transmission processing block 321 for letting the packet through to the next node, and, if determined to be forwarded to the subordinated under the self-device, forwards the packet to the source determining unit 325 at a posterior stage.

Moreover, the receiving RPR packet determining unit 323 determines whether the packet is a control packet on the RPR ring or not, and, if determined to be the control packet, forwards this control packet to the RPR control plane (system control unit) 5.

The source determining unit 325 determines which node on the RPR ring the packet is forwarded from, and reflects (registers) this information in the RPR FDB.

The RPR FDB unit 327 is stored with addresses of the respective nodes configuring the ring and with ring topology information, in which the individual nodes are associated with pieces of destination information of the packets to be transmitted to the nodes. Note that the active RPR card 3W and the non-active RPR card 3P start, as will be described later on, operating with the same contents that are updated in the same way, and hence the RPR FDB unit 327 has invariably the same contents.

<Ringlet IF Unit 4>

The ringlet IF (interface) unit 4 receives (drops) the packet from the ring and transmits (adds) the packet to the ring. The ringlet IF unit 4 is constructed of two blocks 4A, 4B that connects the two neighboring nodes via the transmission path, and each block transmits or receives the packets to or from the dual rings L0, L1. Then, each of the ringlet IF blocks 4A, 4B includes a SEL unit (selecting unit) 41, a Copy unit (copying unit) 42, an OE (Electro-Optical) unit 43 and an OE (Opto-electrical) unit 44.

The SEL unit 41 performs packet-selection so as to send, at a normal state, the packet to the RPR ring from the RPR function block 32 of the active RPR card 3W and so as to send, when a fault occurs, the packet to the RPR ring from the RPR function block 32 of the non-active RPR card 3P.

The Copy unit 42 copies the packet received from the RPR ring, and sends the same packets to the active RPR card 3W and to the non-active RPR card 3P.

The EO unit 43 converts the packet received from the RPR block 32 into an optical signal suited to the physical layer of the RPR ring, and thus transmits the electro-optically converted packet to the ring.

The OE unit 44 converts the packet received from the RPR ring into an electrical signal suited to the physical layer on the network side, and sends the opto-electrically converted packet to the RPR block 3.

<System Control Unit 5>

The system control unit 5 establishes, separately from the forwarding path of the main signals (packets), connections to the respective units such as the packet network IF block 1, the packet SW unit 2, the RPR packet RPR card 3 and the ringlet IF unit 4 within the ringlet ring node 10 via control routes for transmitting or receiving the control information, and thus controls these individual units. The system control unit 5 includes an RPR active system instructing unit 55.

The RPR active system instructing unit 55 detects a fault by monitoring the RPR card 3, and notifies the ringlet IF unit 4 and the RPR card 3 of control information (instructing information) for instructing the use of the active RPR card 3W when any fault does not occur in the active RPR card 3W and of the instructing information for instructing the use of the non-active (standby) RPR card 3P when the fault occurs.

The RPR active system instructing unit 55 monitors the packets passing through the RPR card 3 and a period of response time etc of each of the units, and detects the occurrence of the fault (abnormal status) if deviated from a predetermined status (normal status) such as discontinuance of the packets and elongated response time. For example, a scheme is that a status check packet is transferred at a predetermined cycle, then, if this packet is transferred correctly via a predetermined route, this proves the normal status, and, whereas if not correctly transferred, this proves the abnormal status.

### §2. REDUNDANCY-STRUCTURING (DUALIZATION) METHOD

Given next is a description of a redundancy-structuring method for improving fault-tolerance by relaying the packet in a way that uses a redundant structure.

The discussion will start with explaining an uplink flow of transmitting the packet sent from the terminal-side network toward the ring from the ringlet IF unit 4 via the packet network IF block 1, the packet SW unit 2 and the RPR card 3.

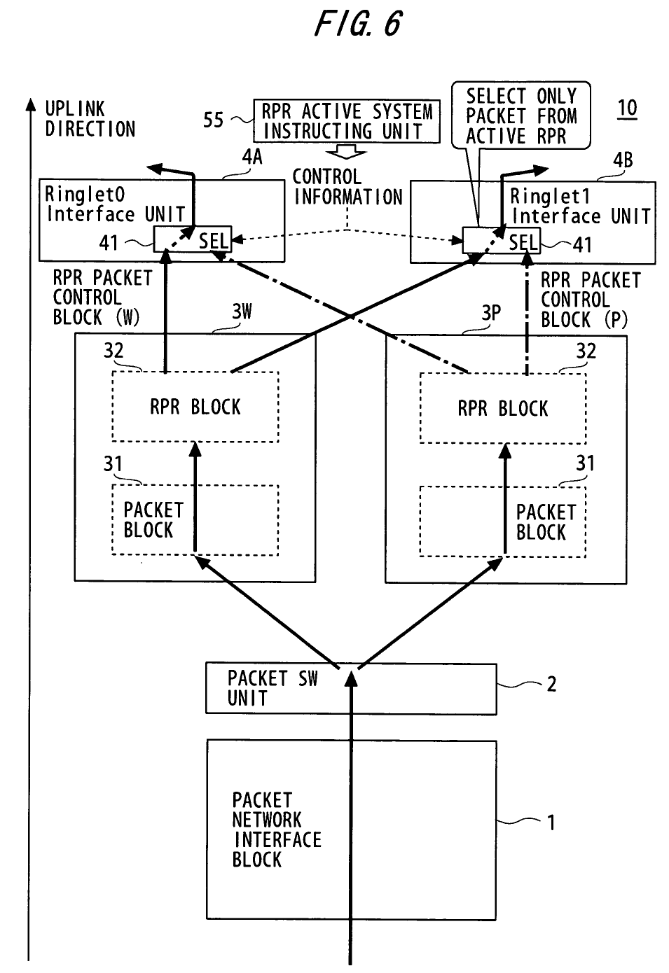

FIG. 6 is a diagram showing a flow of the uplink signal.

In the packet network IF block 1, when the packet is inputted from the terminal side, the destination determining unit 12 determines by referring to the packet FDB the destination, i.e., the forwarding destination associated with the destination information of the packet, and the packet is forwarded to this determined forwarding destination. For example, if the packet destination is the network accommodated by the ring-side node, the packet is forwarded to the packet SW unit 2 via the class determining unit 13 and the packet SW control IF unit 14.

The packet SW unit 2, upon receiving the packet addressed to the RPR card 3, forwards the same data (packets) to the two RPR cards 3W, 3P. Realization of this scheme involves, e.g., a method of copying the received packet and the forwarding the two packets to both of RPR cards.

The active RPR card 3W and the non-active RPR card 3P each receiving the same data execute the same processes, respectively. Namely, the packet block 31 receives the data via the packet SW control IF unit 314, then the source determining unit 315 determines the source of the data, and the source information is reflected (registered) in the packet FDB. For example, information (destination information) such as an input card, an input port, a source address and VLAN information is extracted as the source from the header information of the data (packet) and registered in the packet FDB. Then, the packet is forwarded to the RPR block 32 via the packet accumulating unit 316 from the packet block 31.

In the RPR block 32, when the packet is inputted from the packet block 31, the destination determining unit 322 refers to the RPR FDB 327 and thus determines the destination, i.e., the forwarding destination associated with the destination information of the packet, and the packet is forwarded to the forwarding destination. For instance, if the packet destination is the network accommodated by the ring-side node, the packet is forwarded to the ringlet IF blocks 4A, 4B via the bandwidth control unit 326 and the RPR transmission processing block 321.

In the ringlet IF blocks 4A, 4B, at the normal state, the selecting unit 41 selects, based on the instructing information given from the RPR active system instructing unit 55, the data of the active RPR card 3W from within the same data coming from the active RPR card 3W and from the non-active RPR card 3P, then the selected data is electro-optically converted into the optical signals by the EO unit 43, and the optical signals are transmitted (added) into the rings L0, L1.

Further, if the RPR active system instructing unit 55 detects the fault of the active RPR card 3W and transmits the instructing information for instructing the use of the non-active RPR card 3P to the ringlet IF block 4, the SEL unit 41 selects the data of the non-active RPR card 3P, and the selected data is converted into the optical signals by the EO unit 43 and transmitted (added) into the rings L0, L1.

Given next is an explanation of a downlink flow of transmitting the packet sent from the ring L toward the terminal-side network from the packet network IF block 1 via the ringlet IF unit 4, the RPR card 3 and the packet SW unit 2.

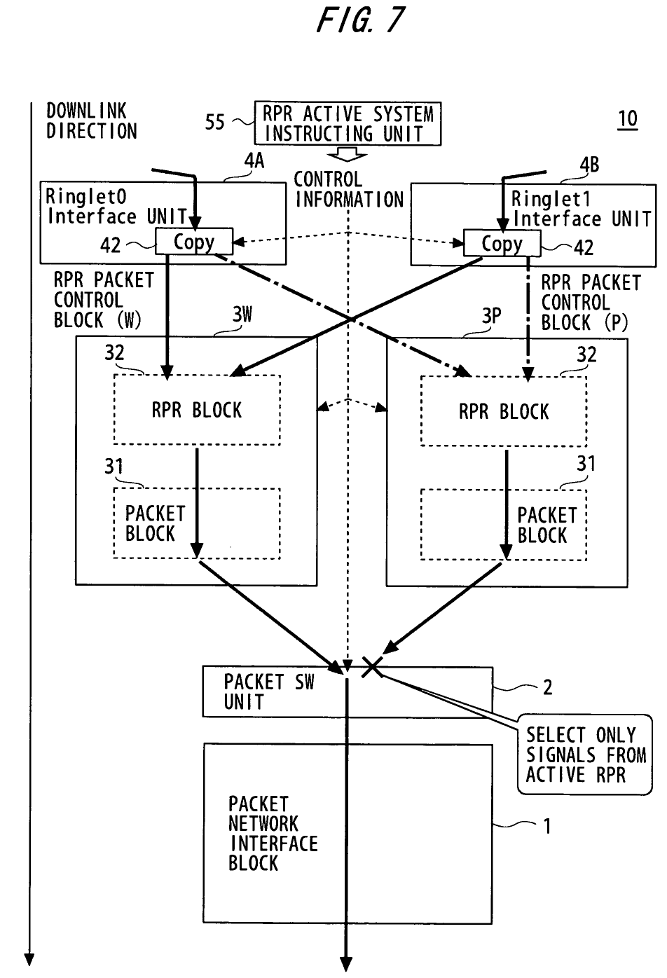

FIG. 7 is a diagram showing the downlink data flow. In the ringlet IF unit 4 receiving the packet from the ringlet L, the OE unit 44 opto-electrically converts the packet, then the Copy unit 42 copies the thus-converted data, and the same pieces of data (packets) are transferred to the active RPR card 3W and to the non-active RPR card 3P.

The active RPR card 3W and the non-active RPR card 3P each receiving the same data execute the same processes, respectively. Namely, the receiving RPR packet determining unit 323 receiving the downlink packet via the MUX unit 324 forwards the packet to the source determining unit 325. The source determining unit 325 determines the information (source information) about the source of the packet and reflects (registers) the source information in the RPR FDB 327.

Thus, the packets received from the ringlets L are forwarded to both of the active RPR card 3W and the non-active RPR card 3P, and the source determining units 325 thereof register the packet-related information in the FDBs according to the necessity. Accordingly, it follows that the pieces of information in the RPR FDBs of the active RPR card 3W and of the non-active RPR card 3P are coincident with each other. Thereafter, the packets are transferred to the packet blocks 31 thereof.

The destination determining unit 312 receiving the packet refers to the packet FDB and thus determines, based on the destination information of the packet, the forwarding destination (destination address) by specifying which card and which port of the card the packet is forwarded to, and the packet is forwarded to the packet SW unit 2 via the intra-device/RPR class determining unit 313 and the packet SW control IF unit 314.

In the packet SW unit 2, at the normal state, the control unit 22 selects, based on the instructing information given from the RPR active system instructing unit 55, the data of the active RPR card 3W from within the same data (packets) coming from the active RPR card 3W and the non-active RPR card 3P, and the data is transmitted to the terminal-side network by sending the data to the packet network IF block 1.

Further, the RPR active system instructing unit 55 detects the fault of the active RPR card 3W and transmits the instructing information for instructing the use of the non-active RPR card 3P to the packet SW unit 2, in which case the control unit 22 selects the data of the non-active RPR card 3P, and the data is transmitted to the terminal-side network by sending the data to the packet network IF block 1.

Thus, the embodiment takes the redundant structure by including the active RPR card 3W and the non-active RPR card 3P, whereby even if the fault occurs in the active RPR card 3W, the operation can continue by the switchover to the non-active RPR card 3P, the RPR node doesn't not get into the system-down, and the initiation of the ring protection function can be prevented. Hence, it is feasible to restrain occurrence of congestion on the ring and a decrease in the bandwidths, which are caused by the activation of the ring protection function.

Moreover, the same packets are sent to the redundancy-structured cards, i.e., both of the active RPR card 3W and the non-active RPR card 3P, and the same processes are executed, whereby the contents of the RPR FDBs 327 of the RPR blocks 32 and the contents of the packet FDBs 317 of the packet blocks 31 are always coincident with each other in their active systems and non-active systems, and no flooding occurs even if the operation starts by the switchover to the non-active RPR card 3P when the fault occurs. It is therefore feasible to further restrain the occurrence of the congestion on the ring and the decrease in the bandwidths.

### §3. MODIFIED EXAMPLES

### First Modified Example

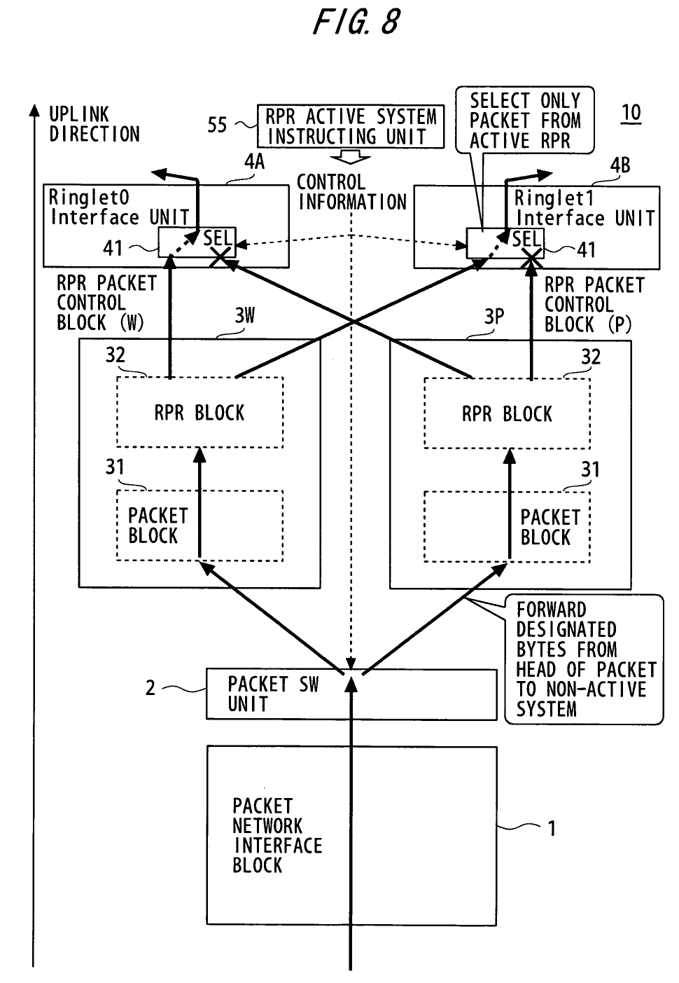

FIG. 8 is an explanatory schematic diagram of a first modified example. A different point of the first modified example from the embodiment discussed above is that on the occasion of forwarding the packet in the uplink direction, the packet SW unit 2 forwards only the header field of the packet to the non-active RPR card 3P. Note that other configurations are the same, and hence the same components are marked with the same symbols and numerals, and their repetitive explanations are omitted.

The RPR active system instructing unit 55 in the first modified example transmits the instructing information to the control unit 22 of the packet SW unit 2 as well as to the ringlet IF unit 4.

The packet SW unit 2, at the normal state, forwards based on the instructing information the packet received from the packet network IF block 1 to the active RPR card 3W, and simultaneously forwards a part (field), containing the source information, i.e., the information needed for updating the packet FDB 317, of the received packet. For example, in such a case that the source information is contained in the header of the packet, only a predetermined count of bytes from the head of the packet, which are registered with the source information, are transferred. In the first modified example, the destination information etc is transferred by forwarding the predetermined count of bytes from the head of the packet, however, the modified example is not limited to this scheme if at least the source information is contained therein. For example, another method is that the source information of the packet is extracted, and only the extracted source information is forwarded.

The active RPR card 3W receiving the whole packet processes the packet as described above in the packet block 31 and in the RPR block 32 and forwards the processed packet to the ringlet IF unit 4, and then the packet is sent to the ring L.

Further, the non-active RPR card 3P receiving the part of the packet determines the source from the part of the packet in the packet block 31, and updates the content of the packet FDB 317. Then, the RPR block 32 determines the forwarding destination from the part of the packet, and, if addressed to another node, the packet is forwarded to the ringlet IF unit 4. The SEL unit 41 of the ringlet IF unit 4, however, selects the data from the active RPR card 3W, and hence the part of the packet coming from the non-active RPR card 3P is discarded.

On the other hand, if the fault occurs in the active RPR card 3W and when the RPR active system instructing unit 55 notifies the packet SW unit 2 of the instructing information purporting that the non-active system be employed, the control unit 22 of the packet SW unit 2 recognizes, based on the instructing information, that the fault occurs, and forwards all the packets received from the packet network IF block 1 to the non-active RPR card 3P. Then, the SEL unit 41 selects the packet from the RPR card 3P and sends the selected packet to the ringlet L.

Thus, at the normal state, only the part of the packet, which is needed for updating the packet FDB 317, is forwarded, and therefore the processes by the non-active RPR card 3P are reduced, thereby enabling the electric power to be saved.

### Second Modified Example

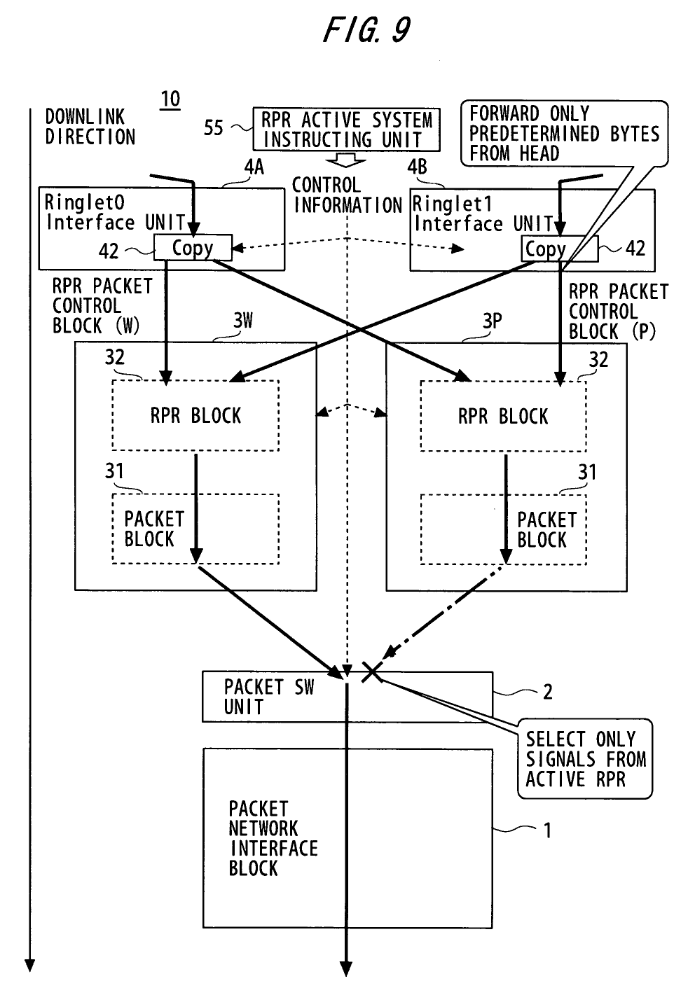

FIG. 9 is an explanatory schematic diagram of a second modified example. A different point of the second modified example from the embodiment discussed above is that on the occasion of forwarding the packet in the downlink direction, the Copy unit 42 forwards only the header field of the packet to the non-active RPR card 3P. Note that other configurations are the same, and hence the same components are marked with the same symbols and numerals, and their repetitive explanations are omitted.

The RPR active system instructing unit 55 in the second modified example transmits the instructing information to the control unit 22 of the packet SW unit 2 as well as to the ringlet IF unit 4.

The packet SW unit 2, at the normal state, forwards based on the instructing information the packet received from the packet network IF block 1 to the active RPR card 3W, and simultaneously forwards a part (field), containing the source information, i.e., the information needed for updating the RPR FDB 327, of the received packet. For example, in such a case that the source information is contained in the header of the packet, only a predetermined count of bytes from the head of the packet, which are registered with the source information, are transferred. In the second modified example, the destination information etc is transferred by forwarding the predetermined count of bytes from the head of the packet, however, the modified example is not limited to this scheme if at least the source information is contained therein.

The active RPR card 3W receiving the whole packet processes the packet as described above in the RPR block 32 and in the packet block 31 and forwards the processed packet to the packet SW unit 2, and then the packet is sent to terminal-side network from the packet network IF block 1.

Further, the non-active RPR card 3P receiving the part of the packet determines the source from the part of the packet in the RPR block 32, and updates the content of the RPR FDB 327. Then, the packet block 31 determines the forwarding destination from the part of the packet, and, if addressed to the terminal-side network, the packet is forwarded to the packet SW unit 2. The control unit 22 of the packet SW unit 2, however, selects the data from the active RPR card 3W, and hence the part of the packet coming from the non-active RPR card 3P is discarded.

On the other hand, if the fault occurs in the active RPR card 3W and when the RPR active system instructing unit 55 notifies the ringlet IF unit 4 of the instructing information purporting that the non-active system be employed, the Copy unit 42 of the ringlet IF unit 4 recognizes, based on the instructing information, that the fault occurs, and forwards all the packets received from the ringlet L to the non-active RPR card 3P. Then, the packet SW unit 2 selects the packet from the RPR card 3P and sends the selected packet to the packet network IF unit 1.

Thus, at the normal state, only the part of the packet, which is needed for updating the RPR FDB 327, is forwarded, and therefore the processes by the non-active RPR card 3P are reduced, thereby enabling the electric power to be saved.

### Third Modified Example

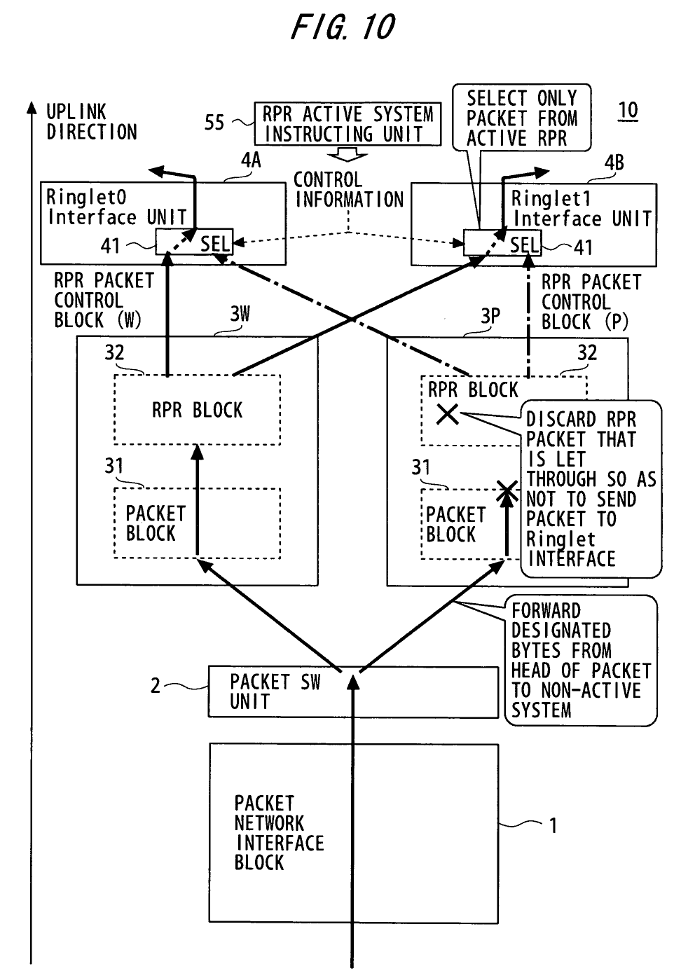

FIG. 10 is an explanatory schematic diagram of a third modified example. A different point of the third modified example from the first modified example discussed above is that on the occasion of forwarding the packet in the uplink direction, the non-active RPR card 3P, after updating the packet FDB, discards the packet. Note that other configurations are the same, and hence the same components are marked with the same symbols and numerals, and their repetitive explanations are omitted.

The packet communication system permits none of a dual arrival of the packet and must therefore take the scheme of forwarding only one packet in the case of dually transmitting the packets to the active RPR card 3W and to the non-active RPR card 3P for the redundancy.

The scheme in the embodiment discussed above is that the SEL unit 41 or the packet SW unit 2 selects only the packet from the active RPR card 3W, thereby preventing the dual arrival of the packet.

Namely, the prevention of the dual arrival of the packet is attained by the SEL unit 41 or the packet SW unit 2, and hence it is desirable to take a fail-safe configuration for further improving the fault-tolerance.

Such being the case, an example of taking the fail-safe configuration for preventing the dual arrival of the packet will next be explained.

The RPR active system instructing unit 55 in the third modified example transmits the instructing information to the packet SW unit 2 and the non-active RPR card 3P as well as to the ringlet IF unit 4.

The packet block 31 of the non-active RPR card 3P, with respect to the packet to be forwarded in the uplink direction, after the source determining unit 315 has registered the source information of the packet in the packet FDB 317, if the source determining unit 315 or the packet accumulating unit 316 recognizes the normal status on the basis of the instructing information, stops the transfer to the RPR block 32 by discarding the packet. Note that if the source determining unit 315 or the packet accumulating unit 316 recognizes the fault-occurred status on the basis of the instructing information, the packet is forwarded to the RPR block 32 in the same way as in the embodiment discussed above.

Moreover, the RPR block 32 of the non-active RPR card 3P, if the RPR transmission processing block 321 recognizes the normal status on the basis of the instructing information, stops the transfer to the ringlet IF unit 4 by discarding the received packet. Note that if the RPR transmission processing block 321 recognizes the fault-occurred status on the basis of the instructing information, the packet is forwarded to the ringlet IF unit 4 in the same way as in the embodiment discussed above.

Thus, in the third modified example, at the normal state, the non-active RPR card 3P, since the RPR block 32 or the packet block 31 discards the packet, stops transmitting the packet to the ringlet IF unit 4.

Further, the ringlet IF unit 4 at the normal state selects the packet sent from the active RPR card 3W in the same way as in the embodiment discussed above, i.e., discards the packet sent from the non-active RPR card 3P.

Accordingly, both of the ringlet IF unit 4 and the non-active RPR card 3P stop forwarding the packet, and therefore, even if the fault occurs in any one of these dual components, the dual arrival of the packet can be surely prevented, whereby the high fault-tolerance is ensured.

Furthermore, in the third modified example, both of the RPR block 32 and the packet block 31 in the non-active RPR card 3P discard the packet, and hence, even if the fault occurs in any one of these dual blocks, the transfer of the packet can be surely stopped, thus attaining the fail-safe configuration. Moreover, in the third modified example, the packet block 31 discards the uplink packet, and therefore, at the normal state, the uplink packet does not reach the RPR block 32, whereby a throughput of the RPR block is reduced and the electric power can be saved.

Note that in the third modified example, both of the RPR block 32 and the packet block 31 discard the packet, however, such a scheme may also be taken that according to the necessary fault-tolerance, the packet block 31 forwards the packet, while only the RPR block 32 discards (stops) the packet.

Further, in the non-active RPR card 3P, the components for discarding the uplink packet may include any components, if capable of discarding the packet after updating the packet FDB 317, from the source determining unit 315 downward (downlink side) without being limited to the source determining unit 315 and the RPR transmission processing block 321.

Moreover, in addition to the scheme described above, such a scheme may also be adopted that the RPR active system instructing unit 55 notifies the active RPR card 3W of the instructing information, and, when the active RPR card 3W recognizes the fault-occurred status, the transfer of the packet is stopped in the same way as by the non-active RPR card 3P at the normal state.

### Fourth Modified Example

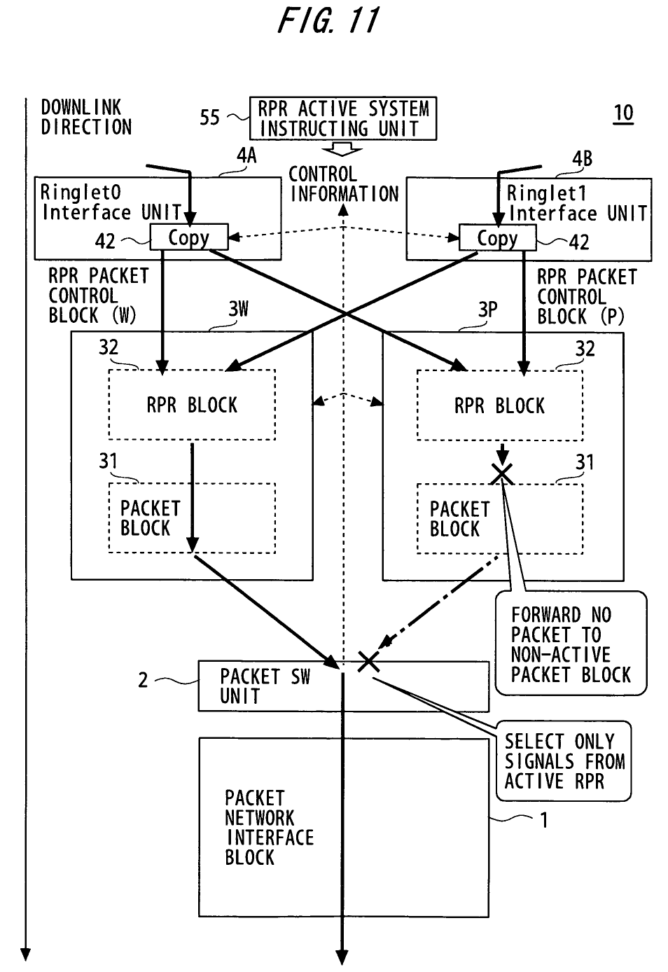

FIG. 11 is an explanatory schematic diagram of a fourth modified example, showing the fail-safe configuration for preventing the dual arrival of the downlink packet. A different point of the fourth modified example from the second modified example discussed above is that the non-active RPR card 3P, after updating the RPR FDB, discards the packet. Note that other configurations are the same, and hence the same components are marked with the same symbols and numerals, and their repetitive explanations are omitted.

The RPR active system instructing unit 55 in the fourth modified example transmits the instructing information to the packet SW unit 2 and the non-active RPR card 3P as well as to the ringlet IF unit 4.

The RPR block 32 of the non-active RPR card 3P, which has received the downlink packet from the ringlet IF unit 4, with respect to this packet, after the source determining unit 325 has registered the source information of the packet in the RPR FDB 327, if the source determining unit 325 recognizes the normal status on the basis of the instructing information, stops the transfer to the packet block 31 by discarding the packet. Further, the RPR transmission processing block 321, when recognizing the normal status on the basis of the instructing information, also discards the packet received from the receiving RPR packet determining unit 323 and addressed to another node. Note that the source determining unit 325 or the RPR transmission processing block 321, when recognizing the fault-occurred status on the basis of the instructing information, gets the packet forwarded to the packet block 31 or the ringlet IF unit 4 in the same way as in the embodiment discussed above.

Further, in the packet block 31 of the non-active RPR card 3P, the destination determining unit 312 and the packet SW control IF unit 314, when recognizing the normal status on the basis of the instructing information, stop the transfer to the packet SW unit 2 by discarding the received packet. Note that the destination determining unit 312 and the packet SW control IF unit 314, when recognizing the fault-occurred status on the basis of the instructing information, forward the packet to the packet SW unit 2 in the same way as in the embodiment discussed above.

Thus, in the fourth modified example, at the normal state, the non-active RPR card 3P, since the RPR block 32 and the packet block 31 discard the downlink packet, thus stops transmitting the packet to the packet SW unit 2.

Further, the packet SW unit 2 at the normal state, similarly to the embodiment discussed above, selects the packet sent from the active RPR card 3W, i.e., discards the packet sent from the non-active RPR card 3P.

Accordingly, both of the packet SW unit 2 and the non-active RPR card 3P stop forwarding the packet, and therefore, even if the fault occurs in any one of these dual components, the dual arrival of the packet can be surely prevented, whereby the high fault-tolerance is ensured.

Furthermore, in the fourth modified example, both of the RPR block 32 and the packet block 31 in the non-active RPR card 3P discard the packet, and hence, even if the fault occurs in any one of these dual blocks, the transfer of the packet can be surely stopped, thus attaining the fail-safe configuration. Moreover, in the fourth modified example, the RPR block 32 discards the downlink packet, and therefore, at the normal state, the uplink packet does not reach the packet block 31, whereby the throughput of the packet block 31 is reduced and the electric power can be saved.

Note that in the fourth modified example, both of the RPR block 32 and the packet block 31 discard the packet, however, such a scheme may also be taken that according to the necessary fault-tolerance, only the packet block 31 discards (stops) the packet.

Further, in the non-active RPR card 3P, the components for discarding the downlink packet may include any components, if capable of discarding the packet after updating the RPR FDB 327, from the source determining unit 325 downward (downlink side) without being limited to the source determining unit 325 and the destination determining unit 312.

Moreover, in addition to the scheme described above, such a scheme may also be adopted that the RPR active system instructing unit 55 notifies the active RPR card 3W of the instructing information, and, when the active RPR card 3W recognizes the fault-occurred status, the transfer of the packet is stopped in the same way as by the non-active RPR card 3P at the normal state.

### §4. SYNCHRONIZATION OF DATABASES IN TERMINATION BLOCK

The embodiment involves forwarding the same packet to both of the redundant active RPR card 3W and the redundant non-active termination block, and making coincident the (contents of) the databases on both sides.

If the pieces of information in the databases are different between the active system and the non-active system, there might be a possibility of causing the congestion due to a large amount of flooding produced when switching over the active RPR card 3W undergoing the occurrence of the fault to the non-active RPR card 3P, the scheme described above intends to prevent this congestion.

For example, at the normal state, the ringlet IF unit 4 forwards the downlink packet to only the active RPR card 3W, while the non-active RPR card 3P is prevented from operating, in which scheme the source information is not registered in the RPR FDB 327 of the non-active RPR card 3P.

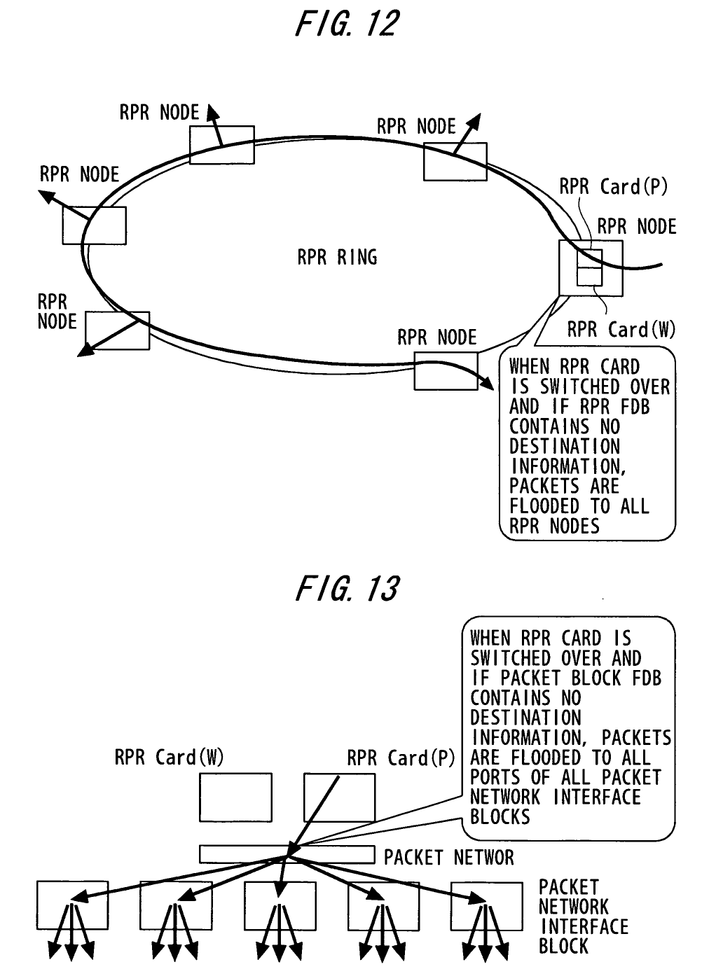

Accordingly, on the occasion of the switchover to the non-active RPR card 3P when the fault occurs in the active RPR card 3W, the information (the corresponding destination) does not exist in the RPR FDB 327 even if the destination determining unit 322 refers to the RPR FDB 327, and therefore, as illustrated in FIG. 12, it follows that all the packets are flooded to all the nodes.

Similarly, at the normal state, the packet SW unit 2 forwards the uplink packet to only the active RPR card 3W, while the non-active RPR card 3P is prevented from operating, in which scheme the source information is not registered in the packet FDB 317 of the non-active RPR card 3P.

Accordingly, on the occasion of the switchover to the non-active RPR card 3P when the fault occurs in the active RPR card 3W, the information (the corresponding destination) does not exist in the packet FDB 317 even if the destination determining unit 312 refers to the packet FDB 317, and therefore, as illustrated in FIG. 13, it follows that all the packets are flooded to all the ports.

Such being the case, the (contents of) database of the active termination block is made coincident (which is also termed “synchronized”) with the (contents of) database of the non-active block 3P, thereby restraining the flooding.

The synchronization of the databases involves the following two steps.

Step 1: Synchronization of an initial status of the RPR card database (initial synchronization).

Step 2: Synchronization of additional information of the RPR card database (normal synchronization).

The synchronization of the additional information in step 2 is carried out as follows.

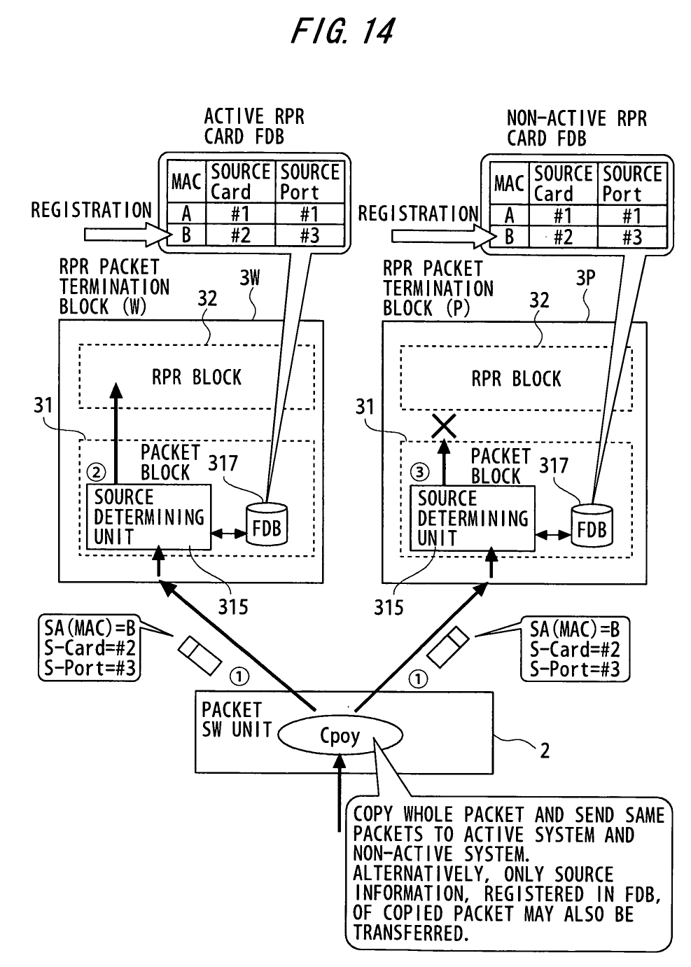

FIG. 14 is an explanatory diagram in the case of forwarding the packet in the uplink direction.

The packet SW unit 2, when receiving the packet addressed to another node from the packet network IF block 1, forwards the packet to the active RPR card 3W and to the non-active RPR card 3P. The packet SW unit 2 in the present example sends the whole packet to the active RPR card 3W, and copies and then sends only the predetermined count of bytes (only the header field) from the head of the packet to the non-active RPR card 3P. Note that the whole packet may be, as in FIG. 6, copied, and thus the same data (packet) may also be sent to the active RPR card 3W and to the non-active RPR card 3P.

The source determining units 315 of the active RPR card 3W and of the non-active RPR card 3P discriminate (extract) source-related information (which will hereinafter be simply referred to as the source information) such as a MAC address, identifying information of the source card and identifying information of the source port from the header of the packet, and register the source information in the FDBs 317.

An example in FIG. 14 shows a case in which a MAC address as a source address (SA) of the packet is “B”, a source card (S-Card) accommodating the packet is “#2”, and a source port (S-Port) is “#3”.

The source determining unit 315 extracts SA=B, S-Card=#2 and S-Port=#3 as the source information from the packet and registers the source information in the FDB 317.

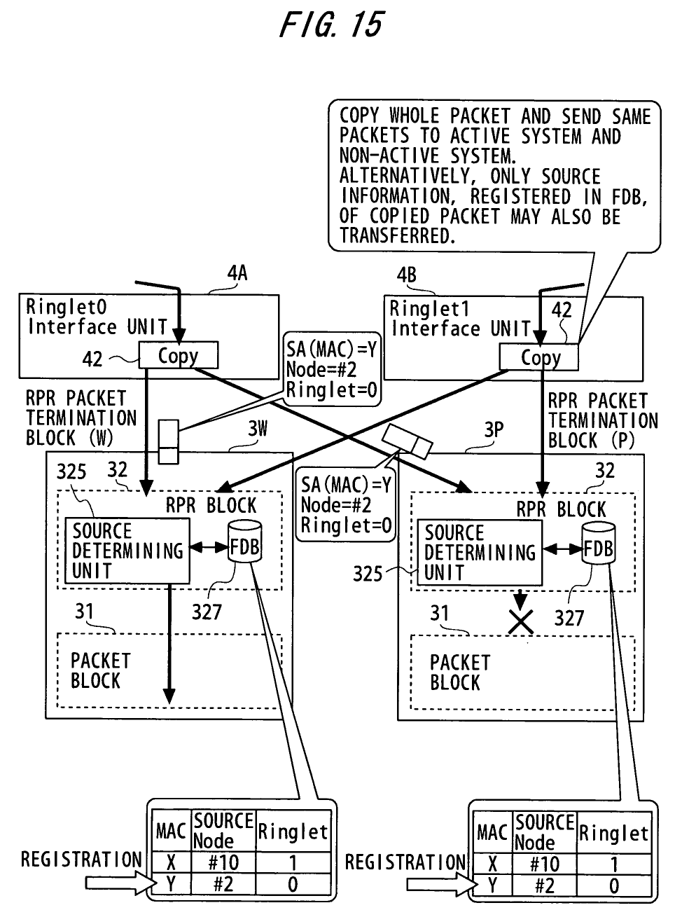

FIG. 15 is an explanatory diagram in the case of forwarding the packet in the downlink direction.

The ringlet IF block 4A and B, upon receiving the packet from the ring side, forwards the packet to the active RPR card 3W and to the non-active RPR card 3P. The packet SW unit 2 in the present example sends the whole packet to the active RPR card 3W, and copies and then sends only the predetermined count of bytes (the header field) from the head of the packet to the non-active RPR card 3P. Note that the whole packet may be, as in FIG. 7, copied, and thus the same data (packet) may also be sent to the active RPR card 3W and to the non-active RPR card 3P.

The source determining units 325 of the active RPR card 3W and of the non-active RPR card 3P discriminate (extract) the source-related information (which will hereinafter be simply referred to as the source information) such as the MAC address of the source, the identifying information of the source node and identifying information of the ringlet from the header of the packet, and register the source information in the FDBs 327. Further, ring topology information and Fairness information contained in a control packet (control frame) are similarly registered in the packet FDBs 327, thus synchronizing the databases. Thus, according to the present application, the information such as the ring topology information representing a topology of the transmitting side (ring side) and the Fairness information will be described generically as the source-related information (source information).

An example in FIG. 15 shows a case in which a MAC address as a source address (SA) of the packet is “Y”, a source node (Node) accommodating the packet is “#2”, and a ringlet (Ringlet) is “#0”.

The source determining unit 325 extracts SA=Y, Node=#2 and Ringlet=#0 as the source information from the packet and registers the source information in the FDB 327.

In step 2, the active RPR card 3W and the non-active RPR card 3P always execute the same registering process (synchronization at the normal state) on the basis of the same source information, and therefore, if the initial synchronization is conducted in step 1, the (contents of) active FDBs 317, 327 are coincident (synchronized) with the (contents of) the non-active FDBs 317, 327.

Then, the initial synchronization in step 1 is carried out as follows.

To begin with, if both of the active RPR card 3W and the non-active RPR card 3P are in the initial status, which means that both of the databases are cleared and are coincident with each other in a nothing-registered status, the databases can be hereafter synchronized by accumulating the additional information in step 2.

Further, when changed over (switched over) due to the occurrence of the fault in one termination block, the database of the changed-over termination block is cleared, and, if the synchronization at the normal state is started in an as-is status, the active database and the non-active database get into a discrepant status (where the non-active database has less of entries). Then, the information accumulated in the database of the termination block under operation is mirrored to the database, and, after completing the mirroring, the synchronization at the normal state in step 2 is performed, thereby enabling the synchronization to be done.

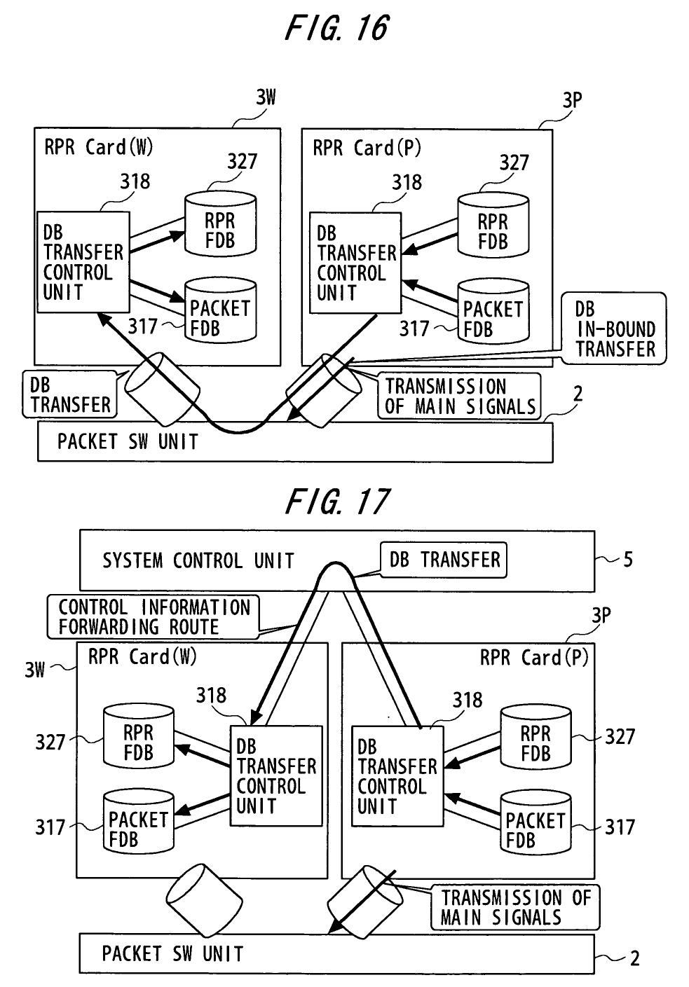

FIG. 16 shows an example of forwarding the source information via the same forwarding route as that of the main signals (packet).

In the case of the operation through the switchover to the non-active RPR card 3P due to the occurrence of fault in the active RPR card 3W, when the active RPR card 3W is changed over, the DB transferring unit 318 detects the changeover, then reads the information in the RPR FDB 327 and the information in the packet FDB, and transfers the readout information as packets for the synchronization to the packet SW unit 2.

Moreover, the packet SW unit 2, when receiving the packets for the synchronization from the non-active RPR card 3P, forwards these packets to the active RPR card 3W.

Then, in the active RPR card 3W, the packet SW control IF unit 314 forwards the received packets for the synchronization to the DB transfer unit 318, and the DB transfer unit 318 registers the source information in the RPR FDB 327 and in the packet FDB, thereby completing the initial synchronization.

Note that when the non-active RPR card 3P is changed over, the initial synchronization can be also performed in such a way that the DB transfer unit transfers the data in the direction opposite to the previous direction.

After the completion of the initial synchronization, the synchronization of the databases can be maintained by performing the synchronization at the normal state.

Incidentally, the description given above illustrates the active system and the non-active system fixedly, however, an available scheme is that the operation starts at a point of time when the fault occurs, i.e., the termination block (which is originally the non-active RPR card 3P) on the side where the packet SW unit 2 and the ringlet IF unit 4 select the packet is set as the active termination block (3W), and the post-changeover termination block is set as the non-active RPR card 3P.

Further, the DB transfer unit 318 notifies the active system instructing unit 55 of the completion of the initial synchronization, and the active system instructing unit 55 may re-notify of the instructing information to select the packet from the active RPR card 3W after the changeover.

Moreover, FIG. 17 shows an example of forwarding the source information via the control route.

If the fault occurs in the active RPR card 3W and if operated through the switchover to the non-active RPR card 3P, when the active RPR card 3W is changed over, the DB transfer unit 318 detects the changeover thereof, then reads the information in the RPR FDB 327 and the information in the packet FDB, subsequently sets the readout information as the information for the synchronization, and transfers the information to the system control unit 5 via the control route.

Furthermore, the system control unit 5 forwards the synchronization information received from the non-active RPR card 3P via the control route to the receiving active RPR card 3W.

Then, in the active RPR card 3W, the DB transfer unit 318 registers the received synchronization information as the source information in the RPR FDB 327 and in the packet FDB, thereby completing the initial synchronization. The subsequent operations are the same as those in the example in FIG. 16.

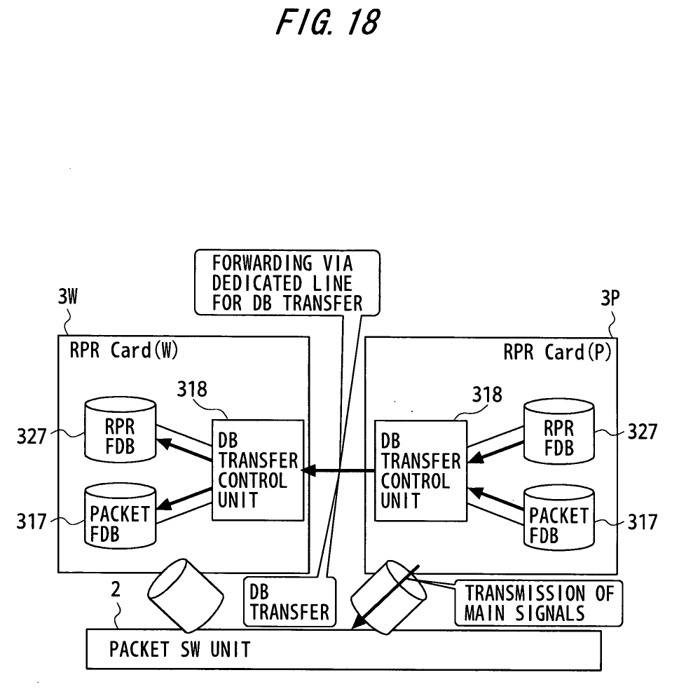

Further, FIG. 18 shows an example of forwarding the source information via a dedicated line 300.

If the fault occurs in the active RPR card 3W and if operated through the switchover to the non-active RPR card 3P, when the active RPR card 3W is changed over, the DB transfer unit 318 of the non-active RPR card 3P detects the changeover thereof, then reads the information in the RPR FDB 327 and the information in the packet FDB, and transfers the information to the DB transfer unit 318 of the active RPR card 3W via the dedicated line 300.

The DB transfer unit 318 of the active RPR card 3W registers the received source information in the RPR FDB 327 and the packet FDB, thereby completing the initial synchronization.

The subsequent operations are the same as those in the example in FIG. 16.

### §5. OTHERS

The present invention is not limited to only the illustrative examples described above and can be, as a matter of course, modified in many forms within the scope that does not deviate from the gist of the present invention.

What is claimed is:

1. A ring node building up a ring network, comprising:
a ring-side interface receiving data from the ring or transmitting the data to the ring;
an active termination block forwarding the data from the ring to a terminal side or forwarding the data from the terminal side to the ring;
a non-active termination block redundancy-structuring a forwarding function of the data by having the same configuration as the active termination block has; and
a terminal-side interface selecting the data sent from the active termination block in the data from the active termination block and from the non-active termination block, then forwarding the selected data to the terminal side, and forwarding the data from the terminal side to the active termination block and to the non-active termination block,
each of the active termination block and the non-active termination block including:
a source determining unit determining source information of the data received from the terminal side, and registering the source information in a database; and
a destination determining unit determining destination information of the data received from the ring by referring to the database.

2. The ring node according to claim 1, wherein the ring-side interface forwards the data received from the ring to the active termination block and to the non-active termination block, then selects the data from the active termination block in the data from the active termination block and from the non-active termination block, and forwards the selected data to the ring side, and
each of the active termination block and the non-active termination block includes:
the source determining unit and the destination determining unit;
a source determining unit determining the source information of the data received from the ring side, and registering the source information in a database; and
a destination determining unit determining a forwarding destination of the data by referring to the database on the basis of the destination information of the data received from the terminal side.

3. The ring node according to claim 1, wherein the non-active termination block, after registering the source information of the data in the database, discards the data.

4. The ring node according to claim 2, wherein each of the active termination block and the non-active termination block includes a terminal-side block and a ring-side block,
the terminal-side block includes: the source determining unit determining the source information of the data received from the terminal side, and registering the source information in the database; and the destination determining unit determining the destination information of the data received from the ring by referring to the database,
the ring-side block includes: a source determining unit determining the source information of the data from the ring side, and registering the source information in the database; and a destination determining unit determining the forwarding destination of the data by referring to the database on the basis of the destination information of the data received from the terminal side, and
the terminal-side block and/or the ring-side block of the non-active termination block, after registering the source information of the data in the database, discards the data.

5. The ring node according to claim 1, wherein the ring-side interface forwards the whole data received from the ring to the active termination block, and forwards a part, related to the source information, of the data received from the ring to the non-active termination block.

6. The ring node according to claim 1, wherein the terminal-side interface forwards the whole data received from the terminal side to the active termination block, and forwards a part, related to the source information, of the data received from the terminal side to the non-active termination block.

7. The ring node according to claim 1, wherein each of the active termination block and the non-active termination block includes:
a database transfer unit transferring, when detecting a changeover to another termination block, the information in the database to the changed another termination block; and
a database initial registering unit registering, when receiving the information from the database transfer unit in the database, the information in a database.

8. The ring node according to claim 7, wherein the database transfer unit transfers the information in the database to the terminal-side interface via a transfer route of the data, and
the terminal-side interface transfers the information in the database to the database initial registering unit via the transfer route of the data.

9. The ring node according to claim 7, wherein the database transfer unit transfers the information to the database initial registering unit via a communication route of control information.

10. The ring node according to claim 7, wherein the database transfer unit transfers the information to the database initial registering unit via a dedicated communication route.

11. A redundancy method for a ring node including a ring-side interface, an active termination block, a non-active termination block and a terminal-side interface, the method, executed by the ring node, comprising steps of:
getting the terminal-side interface to forward data from a terminal side to the active termination block and to the non-active termination block;
getting the active termination block and the non-active termination block to determine source information of the data received from the terminal side and to register the source information in a database;
getting the active termination block to forward the data to the ring-side interface;
getting the ring-side interface to send the data to the ring;
getting the ring-side interface to receive the data from the ring and to forward the data to the active termination block and to the non-active termination block;
getting the active termination block to determine destination information of the data received from the ring-side interface by referring to the database, and to forward the data to the terminal-side interface; and
getting the terminal-side interface to select the data from the active termination block in the data from the active termination block and from the non-active termination block, and to forward the selected data to the terminal side.

12. The redundancy method according to claim 11, further comprising steps of, as those executed by the ring node:
getting the ring-side interface to forward the data received from the ring to the active termination block and to the non-active termination block;
getting the active termination block and the non-active termination block to determine the source information of the data received from the ring side, and to register the source information in a database;
getting the active termination block to determine destination information of the data received from the terminal-side interface by referring to the database, and to forward the data to the ring-side interface; and
getting the ring-side interface to select the data from the active termination block in the data from the active termination block and from the non-active termination block, and to forward the selected data to the ring.

13. The redundancy method according to claim 11, wherein the non-active termination block, after registering the source information of the data in the database, discards the data.

14. The redundancy method according to claim 12, wherein each of the active termination block and the non-active termination block includes a terminal-side block and a ring-side block,
the terminal-side block executes steps of: determining the source information of the data received from the terminal side and registering the source information in the database; and determining the destination information of the data received from the ring by referring to the database,
the ring-side block executes steps of: determining the source information of the data received from the ring side and registering the source information in the database; and determining a forwarding destination of the data on the basis of the destination information of the data received from the terminal side by referring to the database, and
the terminal-side block and/or the ring-side block of the non-active termination block, after registering the source information of the data in the database, discards the data.

15. The redundancy method according to claim 11, wherein the ring-side interface forwards the whole data received from the ring to the active termination block, and forwards a part, related to the source information, of the data received from the ring to the non-active termination block.

16. The redundancy method according to claim 11, wherein the terminal-side interface forwards the whole data received from the terminal side to the active termination block, and forwards a part, related to the source information, of the data received from the terminal side to the non-active termination block.

17. The redundancy method according to claim 11, wherein each of the active termination block and the non-active termination block transfers, when detecting a changeover to another termination block, the information in the database to the changed another termination block; and registers, when receiving the information in the database, the information from the database transfer unit in a database.

18. The redundancy method according to claim 17, wherein the information in the database is forwarded to the terminal-side interface via a forwarding route of the data, and
the terminal-side interface forwards the information in the database to another termination block via the forwarding route of the data.

19. The redundancy method according to claim 17, wherein the information in the database is forwarded via a communication route of control information of each of the active termination block and the non-active termination block.

20. The redundancy method according to claim 17, wherein the information in the database is forwarded via a dedicated communication route.
